(19) United States
(12) Patent Application Publication
(10) Pub. No.: US 2013/0213315 A1
(43) Pub. Date: Aug. 22, 2013

(54) PORTABLE PET GROOMING AID DEVICE AND PET CARRIER

(71) Applicant: Joyce A. Dorfman, Duncanville, TX (US)

(72) Inventor: Joyce A. Dorfman, Duncanville, TX (US)

(21) Appl. No.: 13/399,492

(22) Filed: Feb. 17, 2012

(51) Int. Cl. A01K 29/00; A01K 1/00; A01K 13/00; A01K 15/04

(52) U.S. Cl. 119/496; 119/752; 119/601; 119/600

(57) ABSTRACT

Disclosed is a portable pet grooming aid device comprising a substantially rectangular piece of flexible fabric comprising four sides, two sides joined creating a tubular flexible body having a top face, an inner face, a head end and a tail end, the ends comprising a seam, an elastic cord threaded inside of the seam, two apertures on the top face, the apertures affording a user's hands access to the interior of the device to handle an animal inside of the device during a grooming process, the animal's head exposed outside of the device at the head end, the elastic cord securely tied around the animal's neck.

### BACKGROUND OF THE INVENTION

The disclosed invention is directed to devices that facilitate the washing of an animal. Bathing a pet such as a dog can be a trying process. Containing the pet during the bathing is a challenge. Transporting the animal to and from the groomer can be challenging too. Maintaining a clean environment in the grooming area is also a challenge because the dog will tend to want to shake off the body wetness and along with it splatter grooming chemical products, moisture, and loose hair onto the grooming environment. The disclosed device addresses the above challenges associated with management of an animal during and after a grooming process.

Improved pet carriers are known. See for example U.S. Pat. No. 7,040,254 to Rucker at al. entitled “Transportable animal washing apparatus” and U.S. Pat. No. 7,934,473 to Jonathan Mirsky entitled “Pet carrier access portal.” The applicant however is not aware of an inexpensive, simply-constructed portable pet containment and pet grooming aid device having the benefits and features as described herein.

### SUMMARY OF THE INVENTION

Disclosed is a portable pet grooming device comprising a substantially rectangular piece of flexible fabric comprising four sides, two sides joined creating a tubular flexible body having a top face, an inner face, a head end and a tail end, the ends comprising a seam, an elastic cord threaded inside of the seam, two apertures on the top face, the apertures spaced apart to afford a user's hands access to the interior of the device to handle an animal inside of the device during a grooming process, the animal's head exposed outside of the device at the head end, the elastic cord securely tied around the animal's neck. The disclosed device may optionally be used as a disposable device or as a multiple-use, washable device.

Per one embodiment the device is constructed of a fabric that is a silky, smooth nylon that repels hair such as the fabric used for customer garments (gowns) at hair salons. Per an alternative embodiment, the fabric is a transparent (or opaque) plastic material such as that used in shower curtains. Per another embodiment of the disclosed device, the fabric comprises an interior layer of absorbent material such as terrycloth. Per yet another embodiment, the fabric is an absorbent cotton or cotton blend fabric such as that typically used for patient examination gowns in medical offices. Alternatively, the fabric may be a material that has stretch and recovery properties, such as, by way of example and not by way of limitation, LYCRA®. The preferred embodiment of the disclosed device comprises an elastic cord in the tail end and the head end that the user manually ties to secure the pet inside of the device. The elastic cord may be a closed loop or alternatively it may be a length of elastic with two ends that loosely adapts to the animal's neck and tail without pinching the animal.

The disclosed pet grooming aid device is readily cleaned after the animal is removed from the device. As an example and not by way of limitation, the disclosed device may be reversed inside out to expose and wash its inner face. Alternatively, the device may simply be shaken to loosen and discard hair and residue from the pet cleaning. The device embodiment constructed of hair-repelling nylon is especially suited for the latter type of cleaning.

The device is also suitable as a pet carrier to help minimize the occurrence of loose pet hair in the environment. Thus, the disclosed device may be used as a pet containment/pet carrier device in combination with a standard car seatbelt. The male portion of the seatbelt is threaded through one aperture (or both apertures) of the disclosed device, and then locked into the female or buckle portion of the car seatbelt. In such uses, the disclosed device promotes the animal's safety in the car while promoting a clean and dry environment inside of the car even when transporting a freshly-groomed animal. Per one embodiment of such pet carrier device, the device is constructed of fabric that has stretch and recovery properties.

The loop ends are preferably manually adjustable to securely and comfortably contain the pet inside of the device during grooming. The ends may be adapted with or without elastic tie or other suitable means designed to secure the head end and the tail end of the device with the pet securely inside of the device.

In use, the head of the animal is inserted inside the tail end of the device, then exposed on the head end of the device, the head end and tail end loosely tied. Preferably the tail of the animal is kept inside of the device with the tail end of the device securely tied. With the animal securely inside of the device, the groomer passes his/her hands through the apertures on the top face of the device to gain access to the animal and to control the animal during the washing. Water may be introduced into the device during washing by way of the apertures in the top face of the device. At the end of the washing procedure, water may be manually squeezed out of the device at the apertures and/or the ends of the device, or it may be vacuumed out of the device at the apertures. The animal preferably is manually dried at the end of the washing procedure while the animal is still in the device. The disclosed device is also suited for use in grooming procedures that involve dry powder shampooing, application of flee powder and/or other topical medications. To release the pet, the loops or ties at the head end of the device are loosened allowing the animal to exit the device or be removed from the device. The animal is allowed to exit the device preferably after the animal is manually dried while the animal is still inside of the device.

### BRIEF DESCRIPTION OF THE DRAWINGS

FIG. 1 is a perspective of a preferred embodiment of the disclosed pet grooming aid device.

FIG. 2 is perspective of a loop securement of the disclosed pet grooming aid device.

FIG. 3 is a top perspective of the preferred embodiment of the disclosed pet grooming aid device.

FIG. 4 is a perspective of an end of the disclosed device.

FIG. 5 is a perspective of an end per an alternative version of the preferred embodiment of the disclosed pet grooming aid device.

FIG. 6 is a side perspective of the disclosed pet grooming aid device in use with a car seatbelt.

FIG. 7 is a front perspective of the disclosed pet grooming aid device in use with a car seatbelt.

FIG. 8 is a perspective of an alternative embodiment of the disclosed, pet grooming aid device

### DETAILED DESCRIPTION OF THE DRAWINGS

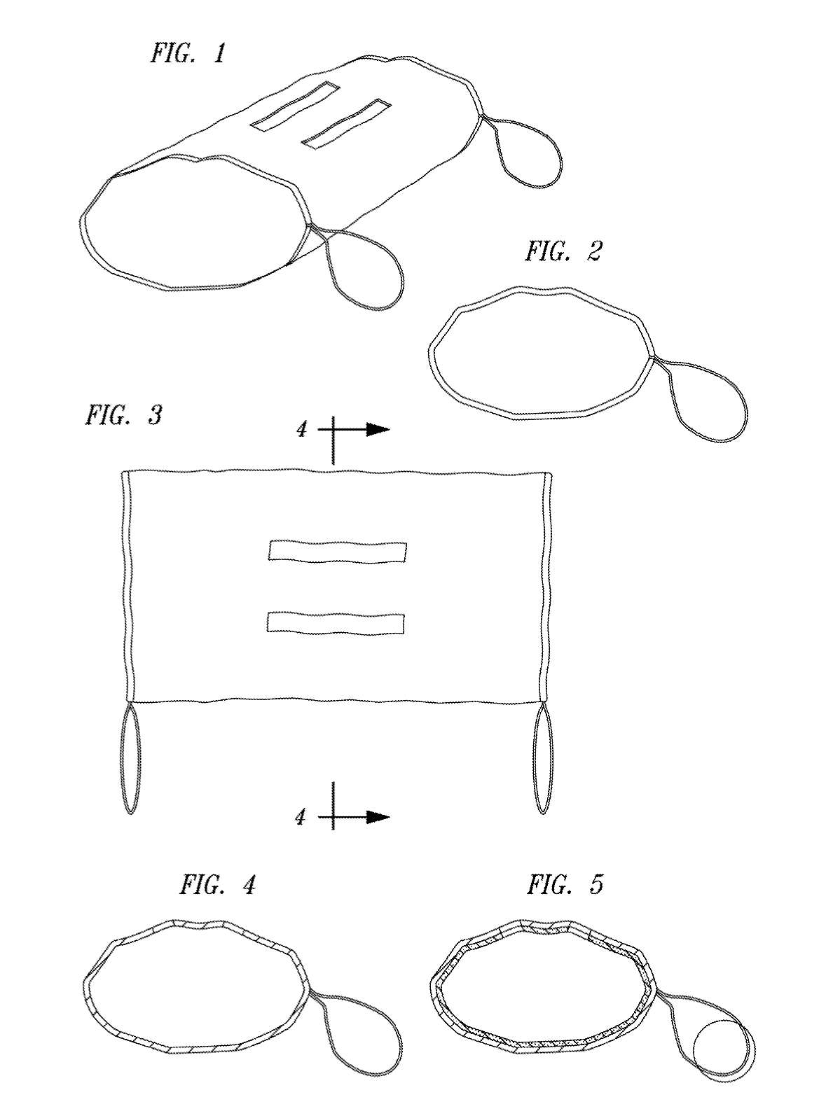

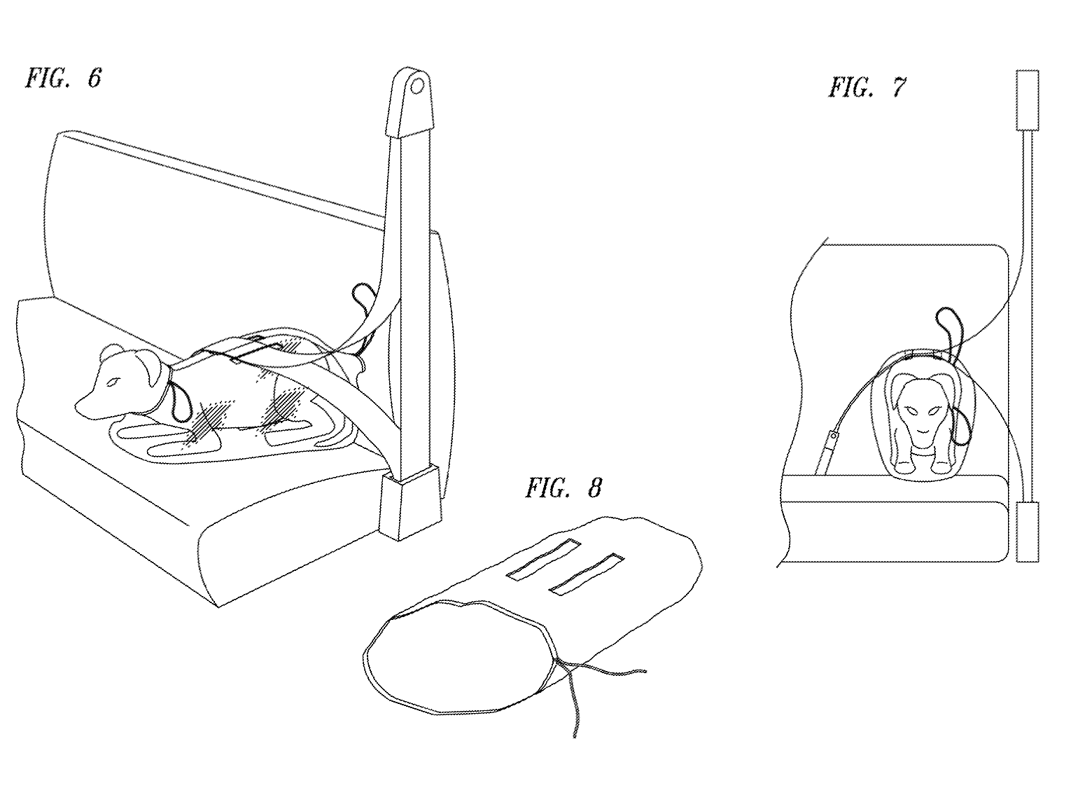

FIG. 1 is a perspective of a preferred embodiment of the disclosed pet grooming aid device 10 ready to receive a pet for grooming. Shown are two slits or apertures 40, tail end or opening 30, head end or opening 20, and elastic tie loops 50. FIG. 3 is a top view of the disclosed device when its flexible fabric is flattened. FIG. 5 is a perspective of an end per an alternative embodiment of the disclosed pet grooming aid device 10 comprising an inner surface comprising an absorbent layer 70 constructed of material such as terrycloth. FIGS. 6 and 70 show the disclosed pet grooming aid device used as a pet carrier and pet securement device inside of a car. The male portion of the seatbelt 80 is threaded through one or both apertures 40 of the device and then locked with the female buckle portion of the seatbelt securing the pet to the car seat with the pet contained inside of the device. FIGS. 6 and 7 show the pet's tail optionally left outside of the device 10, wherein the tail end of the device is loosely tied with the pet's tail left outside of the device.

FIG. 8 shows an alternative embodiment that is pouch-like. Shown in FIG. 8 is a portable pet grooming aid device comprising a flexible fabric formed in a pouch having a body and an open end, the body of the pouch comprising a first aperture and a second aperture spaced apart to allow a groomer's hands access to an'animal inside of the pouch, the open end comprising a tiable cord. The cord may be made of thread or elastic or another suitable material.

I claim:

1. A portable pet grooming aid device comprising a substantially rectangular piece of flexible fabric comprising four sides, two sides joined creating a tubular flexible body having a top face, a bottom face, an outer face, an inner face, a head end, and a tail end, the ends comprising a seam, a cord threaded inside of the seam, a first aperture and a second aperture on the top face spaced apart to afford a user's hands access to the interior of the device to handle an animal inside of the device during a grooming of the animal, the animal's head exposed outside of the device at the head end during the grooming, the cord loosely tied around the animal's neck.

2. The portable pet grooming aid device per claim 1 wherein the inner face comprises an absorbent fabric.

3. The portable pet grooming aid device per claim 1 wherein the flexible fabric comprises a transparent plastic material.

4. The portable pet grooming aid device per claim 1 wherein the flexible fabric comprises a stretchable material.

5. The portable pet grooming aid device per claim 1 wherein the device is disposable.

6. A portable pet containment device for use in combination with a car seatbelt comprising a male portion and a female buckle portion, the device comprising a substantially rectangular piece of flexible fabric comprising four sides, two sides joined creating a tubular flexible body having a top face, a bottom face, an outer face, an inner face, a head end, and a tail end, the ends comprising a seam, a tiable cord threaded inside of the seam, a first aperture and a second aperture on the top face, the apertures affording a user's hands access to an animal inside of the device, the male portion of the seatbelt inserted through at least one aperture and locked with the female buckle portion, the animal's head exposed outside of the device with its neck securely tied via the elastic cord at the head end.

7. The portable pet containment device per claim 6 wherein the fabric is a stretchable material.

8. A method of managing a pet during grooming comprising the steps of
Providing a pet grooming aid device comprising a substantially rectangular piece of flexible fabric comprising four sides, two sides joined creating a tubular flexible body having a top face, a bottom face, an outer face, an inner face, a head end, and a tail end, the ends comprising a seam, a cord threaded inside of the seam, a first aperture and a second aperture on the top face,
Guiding the pet's head through the tail end of the device and out of the head end of the device,
Tying the elastic cord at the head end of the device to secure the pet's neck,
Tying the cord at the tail end to securely contain the pet inside of the device,
Passing one hand through each of the apertures of the device to access the body of the pet inside of the device to wash the pet.

9. The method per claim 4 further comprising the steps of
Transporting the pet inside of a car comprising a seatbelt, the seatbelt comprising a male portion and a female buckle portion,
Threading the male portion of the seatbelt through at least one aperture of the device, the head end and tail end loosely tied and the animal contained inside of the device, and
Locking the male portion with the female buckle portion of the seatbelt.

10. A portable pet grooming aid device comprising a flexible fabric formed in a pouch having a body and an open end, the body of the pouch comprising a first aperture and a second aperture spaced apart to allow a groomer's hands access to an animal inside of the pouch, the open end comprising a tiable cord.
